(19) United States
(12) Patent Application Publication
(10) Pub. No.: US 2023/0129230 A1
(43) Pub. Date: Apr. 27, 2023

(54) ENERGY MANAGEMENT

(71) Applicant: Honda Motor Co., Ltd., Tokyo (JP)

(72) Inventors: John H. HOLMES, San Diego, CA (US); Junlei ZHANG, Long Beach, CA (US); Narith CHOEUN, Long Beach, CA (US); Ryan Douglas Roy HARTY, Long Beach, CA (US); Satoru SHINZAKI, Utsunomiya (JP)

(21) Appl. No.: 17/966,423

(22) Filed: Oct. 14, 2022

Related U.S. Application Data
(60) Provisional application No. 63/271,443, filed on Oct. 25, 2021.

(51) Int. Cl. H02J 3/14; H02J 3/32

(52) U.S. Cl. CPC H02J 3/144; H02J 3/322

(57) ABSTRACT

According to one aspect, a system for energy management may include a processor, a memory, and a communication interface. The communication interface may receive configuration information associated with a microgrid and one or more distributed energy resources (DER). The processor may generate a dispatch profile to control one or more of the DER based on a detected outage, a type of DER connected to the microgrid, a set of default operating conditions, and a user preference. According to one aspect, the processor may generate the dispatch profile based on the dispatch command, a status of a DER of one or more of the DER connected to the microgrid, and a user preference. The dispatch command may include a demand response (DR) request or a vehicle grid integration (VGI) request for real power or reactive power from the microgrid.

### CROSS-REFERENCE TO RELATED APPLICATIONS

This application claims the benefit of U.S. Provisional patent application, Ser. No. 63/271,443 entitled “ELECTRIC VEHICLES, ELECTRIC VEHICLE SUPPLY EQUIPMENT, AND AGGREGATOR DRIVERS”, filed on Oct. 25, 2021; the entirety of the above-noted application(s) is/are incorporated by reference herein.

### BACKGROUND

With an increase in sales of electric vehicles (EV), such as battery electric vehicles (BEV) and plug-in hybrid electric vehicles (PHEV), there is a demand for charging stations to facilitate recharging of those vehicles. Such charging stations may include an electric vehicle supply equipment (EVSE) unit that converts electrical energy received from a source of electrical power into a form that may be received by a vehicle for recharging the vehicle batteries. EVSEs, due to constraints on the grid, may also provide management of costs and energy usage, such as demand response or vehicle-to-grid activities.

### BRIEF DESCRIPTION

According to one aspect, a system for energy management may include a processor, a memory, and a communication interface. The communication interface may receive configuration information associated with a microgrid and one or more distributed energy resources (DER). The processor may generate a dispatch profile to control one or more of the DER based on a detected outage, a type of DER connected to the microgrid, a set of default operating conditions, and a user preference.

One or more of the DER may be a stationary battery, a solar photo-voltaic (PV) system, a fuel cell, a heat pump, or an energy generation device. The processor may control a switch to disconnect the microgrid from a main power grid when the detected outage occurs. The type of DER connected to the microgrid may include a solar photo-voltaic (PV) system or an electric vehicle (EV) including an EV battery. The processor may generate the dispatch profile to control one or more of the DER based on the type of DER connected to the microgrid and a second type of DER connected to the microgrid. The processor may generate the dispatch profile to control one or more of the DER based on time of use (TOU) rate information and a current time. The microgrid may include an electric vehicle supply equipment (EVSE), one or more of the DER, associated inverters, and a main panel.

According to one aspect, a system for energy management may include a processor, a memory, and a communication interface. The communication interface may receive configuration information associated with a microgrid and one or more distributed energy resources (DER). The communication interface may receive a dispatch command from an upstream server. The processor may generate a dispatch profile to control one or more of the DER based on the dispatch command, a status of a DER of one or more of the DER connected to the microgrid, and a user preference.

The type of DER connected to the microgrid may include a solar photo-voltaic (PV) system or an electric vehicle (EV) including an EV battery. The processor may generate the dispatch profile to control one or more of the DER based on time of use (TOU) rate information and a current time. The microgrid may include an electric vehicle supply equipment (EVSE), one or more of the DER, and a main panel. The dispatch command may include a demand response (DR) request. The dispatch command may include a vehicle grid integration (VGI) request for real power or reactive power from the microgrid. The processor may generate the dispatch profile to control one or more of the DER based on the VGI request by drawing the requested real power or reactive power from one or more of the DER.

According to one aspect, a method for energy management may include receiving configuration information associated with a microgrid and one or more distributed energy resources (DER), receiving a dispatch command from an upstream server, generating a dispatch profile to control one or more of the DER based on the dispatch command, a status of a DER of one or more of the DER connected to the microgrid, and a user preference.

The status of the DER of one or more of the DER may include an electric vehicle (EV) connection status or a solar photo-voltaic (PV) system interrupted status. The method for energy management may include generating the dispatch profile to control one or more of the DER based on time of use (TOU) rate information and a current time. The microgrid may include an electric vehicle supply equipment (EVSE), one or more of the DER, and a main panel. The dispatch command may include a demand response (DR) request. The dispatch command may include a vehicle grid integration (VGI) request for real power or reactive power from the microgrid. The processor may generate the dispatch profile to control one or more of the DER based on the VGI request by drawing the requested real power or reactive power from one or more of the DER.

According to one aspect, a system for energy management may include a processor, a memory, and a communication interface. The communication interface may receive a dispatch command from an upstream server, the dispatch command including a demand response (DR) request or a vehicle grid integration (VGI) request. The communication interface may query one or more distributed energy resources (DER) enrolled in an energy program or one or more downstream servers associated with one or more additional DER enrolled in the energy program for configuration information associated with the DR request or the VGI request to generate a query result.

The communication interface may receive configuration information associated with a microgrid associated with one or more of the additional DER. The corresponding query may include a GETEndDeviceList command which returns a roster of applicable end devices associated with the corresponding query. The corresponding query may include a GETEndDevice command which returns an addressable and dispatchable DER end node with a uniquely identifiable communication port to be used for relay of control messages. The corresponding query may include a FunctionSetAssignmentsList command which returns an agreed upon roster of FunctionSets. The corresponding query may include a DERControlList command which returns a roster of applicable control structures supporting DER dispatch for controlling a group of DER. The corresponding query may include a DERProgramList command which returns a roster of applicable utility or market operations programs which support services which DER may be dispatched to fulfill. The corresponding query may include a DERProgram command which may be a command associated with a defined structure for dispatchability of DER to perform a specifically designated function or service. The corresponding query may include a DERInfo command which returns information pertaining to a corresponding DER including a status, an availability, a capability, and a setting of the corresponding DER. One or more of the additional DER may be a stationary battery, a solar photo-voltaic (PV) system, a fuel cell, a heat pump, or an energy generation device.

According to one aspect, a method for energy management may include receiving a dispatch command from an upstream server, the dispatch command including a demand response (DR) request or a vehicle grid integration (VGI) request, querying one or more distributed energy resources (DER) enrolled in an energy program or one or more downstream servers associated with one or more additional DER enrolled in the energy program for configuration information associated with the DR request or the VGI request to generate a query result, and transmitting the query result to the upstream server to indicate whether the DR request or the VGI request is possible.

The method for energy management may include receiving configuration information associated with a microgrid associated with one or more of the additional DER to generate the query result, receiving a roster of applicable end devices associated with the corresponding query to generate the query result, receiving an addressable and dispatchable DER end node with a uniquely identifiable communication port to be used for relay of control messages to generate the query result, receiving an agreed upon roster of FunctionSets to generate the query result, receiving a roster of applicable control structures supporting DER dispatch for controlling a group of DER to generate the query result, receiving a roster of applicable utility or market operations programs which support services which DER may be dispatched to fulfill to generate the query result, receiving a defined structure for dispatchability of DER to perform a specifically designated function or service to generate the query result, or receiving information pertaining to a corresponding DER including a status, an availability, a capability, and a setting of the corresponding DER to generate the query result.

According to one aspect, a system for energy management may include a processor, a memory, and a communication interface. The communication interface may receive a dispatch command from an upstream server, the dispatch command including a demand response (DR) request or a vehicle grid integration (VGI) request. The communication interface may query one or more distributed energy resources (DER) enrolled in an energy program or one or more downstream servers associated with one or more additional DER enrolled in the energy program for configuration information associated with the DR request or the VGI request to generate a query result. The communication interface may transmit the query result to the upstream server to indicate whether the DR request or the VGI request is possible.

### BRIEF DESCRIPTION OF THE DRAWINGS

FIG. 1 is an exemplary component diagram of a system for energy management, according to one aspect.

FIG. 2 is an exemplary component diagram of a system for energy management, according to one aspect.

FIG. 3 is an exemplary component diagram of a system for energy management, according to one aspect.

FIG. 4 is an exemplary component diagram of a system for energy management, according to one aspect.

FIG. 5 is an exemplary component diagram of a system for energy management, according to one aspect.

FIG. 6 is an exemplary component diagram of a system for energy management, according to one aspect.

FIG. 7 is an exemplary component diagram of a system for energy management, according to one aspect.

FIG. 8 is an exemplary component diagram of a system for energy management, according to one aspect.

FIG. 9 is an exemplary flow diagram of a method for energy management, according to one aspect.

FIG. 10 is an illustration of an example computer-readable medium or computer-readable device including processor-executable instructions configured to embody one or more of the provisions set forth herein, according to one aspect.

FIG. 11 is an illustration of an example computing environment where one or more of the provisions set forth herein are implemented, according to one aspect.

FIG. 12 is an exemplary component diagram of a system for energy management, according to one aspect.

FIG. 13 is an exemplary component diagram of a system for energy management, according to one aspect.

FIG. 14 is an exemplary component diagram of a system for energy management, according to one aspect.

FIG. 15 is an exemplary component diagram of a system for energy management, according to one aspect.

FIG. 16 is an exemplary component diagram of a system for energy management, according to one aspect.

FIG. 17 is an exemplary flow diagram of a method for energy management, according to one aspect.

FIG. 18 is an exemplary flow diagram of a method for energy management, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores and may be storage on a “disk” or a “drive”.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

An “electric vehicle” (EV), as used herein, refers to any moving vehicle that is capable of carrying one or more human occupants and is powered entirely or partially by one or more electric motors powered by an electric battery. The EV may include battery electric vehicles (BEVs), plug-in hybrid electric vehicles (PHEVs) and extended range electric vehicles (EREVs). The term “vehicle” includes, but is not limited to: cars, trucks, vans, minivans, SUVs, motorcycles, scooters, boats, personal watercraft, and aircraft. The term “vehicle” may also refer to an autonomous vehicle and/or self-driving vehicle. Further, the term “vehicle” may include vehicles that are automated or non-automated with pre-determined paths or free-moving vehicles. The EV may be powered by an EV motor and an EV storage mechanism, for example, an EV battery. According to one aspect, the EV may be purely electric in that the EV may include the EV motor and the EV battery. According to another aspect, the EV may include the EV motor, the EV battery, and an internal combustion engine (ICE). According to one aspect, the EV may have any number of electric motors, batteries, and/or internal combustion engines and they may operate in series (e.g., as in an extended range electric vehicle), in parallel, or any combination of series and parallel operation.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

A “user,” as used herein may include a being exerting a demand on a source of energy, such as an electrical grid. The demand on the source of energy may be exerted through an energy consuming device and/or a DER. A user may be associated with a household, building, office, and/or EV.

“Common smart inverter protocol” (CSIP) may refer to a communications pathway between a utility and an aggregator or an original equipment manufacturer (OEM) server, etc.

A “distributed energy resource” (DER) may be a relatively small energy system that may produce energy or consume energy which may be located on a consumer side of a meter. A DER may be grid connected or may be dispatched. Examples of DER may include roof top solar photovoltaic (PV) units, wind generating units, battery storage, batteries in electric vehicles (EV), combined heat and power units, tri-generation units, biomass generators, open and closed cycle gas turbines, reciprocating engines, hydro and mini-hydro schemes, fuel cells, etc.

An “energy management system” (EMS) or a system for energy management may be a system of computer-aided tools or devices used by operators of electric utility grids to monitor, control, and optimize the performance of the generation or transmission system. The EMS may be used in small scale systems, such as microgrids. For example, with reference to electric vehicle (EV) charging, the EMS may manage when an EV is charged based on a total load, a total capacity of an electrical service, etc.

An “electric vehicle supply equipment” (EVSE) may be a piece of equipment that supplies electrical power for charging plug-in electric vehicles (e.g., hybrids, neighborhood electric vehicles (EV), trucks, buses, among others) or charging equipment including charging links. EVSEs may utilize a variety of types of connectors.

“Original equipment manufacturer” (OEM) may refer to a company that produces parts and equipment that may be marketed by another manufacturer, a maker of a system that includes other companies' subsystems, an end-product producer, an automotive part that is manufactured by the same company that produced the original part used in the automobile's assembly, or a value-added reseller. OEM may refer to the manufacturer of the original equipment, or the parts assembled and installed during the construction of a new vehicle. An OEM server may be a server maintained by the OEM. An electric vehicle (EV) may be manufactured, owned, and/or operated by the OEM or a user.

“Public Safety Power Shutoff” (PSPS) may refer to scenarios where utilities may turn off power to specific areas to reduce the risk of fires caused by electric infrastructure. The action of turning the power off in these scenarios may be referred to as PSPS or “de-energization”. Explained another way, PSPS may be the purposeful de-energization of power lines to reduce the risk of fires.

V1G may refer to smart charging or unidirectional managed charging. V1G may either turn on or turn off charging to a device via a modulated charge command. V2G may refer to “vehicle-to-grid” activities. V2G may be bidirectional in that the vehicle may provide power to the grid. In other words, instead of merely curtailing load, V2G may mean that there may be a load. This load may be increased to the point that maximum value is utilized and reverse power flow is provided. In this way, battery energy from an EV, for example, may be pushed back onto the grid or into the home or building to reduce energy cost for the premise. In certain scenarios, V2G may be compensated by the utility for the power being put back onto the grid, as metered by meters or by some other metering technology. Other variations may include V2X (vehicle-to-everything), V2B (vehicle-to-building), V2H (vehicle-to-home), or V2L (vehicle-to-load), etc.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

It may be difficult for a user or consumer to manage their electrical usage given the complex nature of electricity markets and the various entities involved. For example, a user may receive energy from one or more utility providers and may also generate their own energy using a number of DER. For example, the user may operate roof top solar PV units, wind generating units, have their own energy storage system (ESS), including batteries in EVs, fuel cells, etc. The DER may supplement the energy received from one or more of the utility providers. Further, the user may sell energy back to one or more of the utility providers, according to one aspect.

The user may also have a number of devices that consume energy, such as the EV (e.g., while the EV is charging), household appliances (e.g., refrigerator, oven, stove top, water heater, washer, dryer, dishwasher, air conditioner, etc.), and electronic devices (e.g., computers, laptops, cable box, television, portable device, etc.). The energy consuming devices may individually communicate with other entities, such as one or more of the utility providers, one or more servers (e.g., OEM server, aggregator server, utility server, etc.), or other third parties.

According to one aspect, EVs may communicate with a number of different entities and may use a variety of communication standards while doing so. For example, the Institute of Electrical and Electronics Engineers (IEEE) 2030.5 may be a standard for vehicle-to-grid (V2G) communications that is directed to messaging between the utility and the EV via one or more intermediate servers.

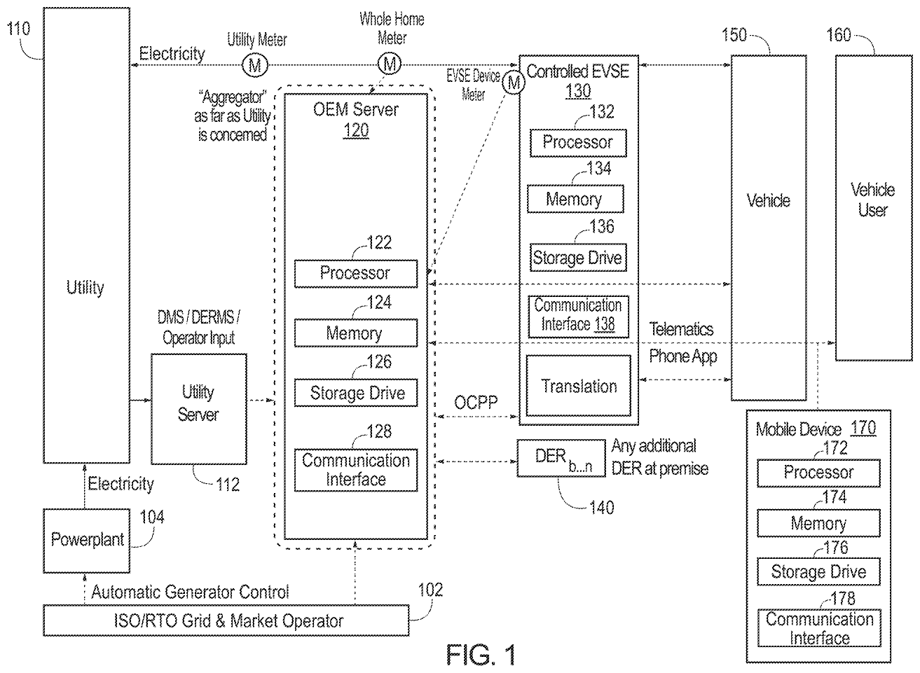

FIG. 1 is an exemplary component diagram of a system for energy management, according to one aspect. In FIG. 1, a market operator 102 or regional transmission operator may control a powerplant 104 which may generate power or electricity. A utility 110 may facilitate delivery of the power to a consumer and may regulate or control this delivery via a utility server 112 and have a fundamental role of providing safe, efficient operation of the grid. Generally, the utility 110 is responsible for providing power to a premise at a point of common coupling and is not chartered to provide after meter services. The utility server 112 or other upstream dispatch source may pass commands, such as dispatch commands along to an aggregator or an original equipment manufacturer (OEM) server 120.

According to one aspect, the OEM server 120, the utility server 112, or other upstream dispatch source may include computing infrastructure such as computing devices that may communicate to and/or with one or more third parties. The OEM server 120 may be accessed by upstream sources to be utilized to process and store configuration information that may include vehicle data, vehicle specifications, pricing data, and/or additional data that may be utilized to process one or more pricing schemes, power schemes, etc. The OEM server 120 may include a computing device that may further include a processor 122, a memory 124, a storage drive 126, and a communication interface 128. The components of any described architecture, including the computing device, may be operably connected for computer communication via a bus and/or other wired and wireless technologies, which, for brevity, will not be described in greater detail herein.

The storage drive 126 may store application data that may also include data pertaining to a policy application. The communication interface(s) 128, 138, 178 described herein may be configured to provide software, firmware, and/or hardware to facilitate data input and output between the components of the computing device and other components, networks, and data sources. According to one aspect, the communication interface(s) 128, 138, 178 may be used for communication (e.g., send and receive data) between the OEM server 120 and one or more OEMs and/or to one or more OEMs from the OEM server 120.

The OEM server 120 may be a server maintained by the OEM of an electric vehicle (EV), for example. As used herein, an ‘upstream dispatch source’ may refer to the market operator 102, the powerplant 104, the utility 110, or the utility server 112. Generally, the utility server 112 may be a source of many of the dispatch commands described herein. However, the market operator 102 may also be the source of the dispatch commands. In any event, one of the upstream dispatch sources may issue the dispatch command and transmit this request to the OEM server 120. As discussed below, the OEM server 120 may include a computing device that is configured to execute a policy application. The policy application may be configured to communicate with one or more utility providers to receive one or more dispatch commands.

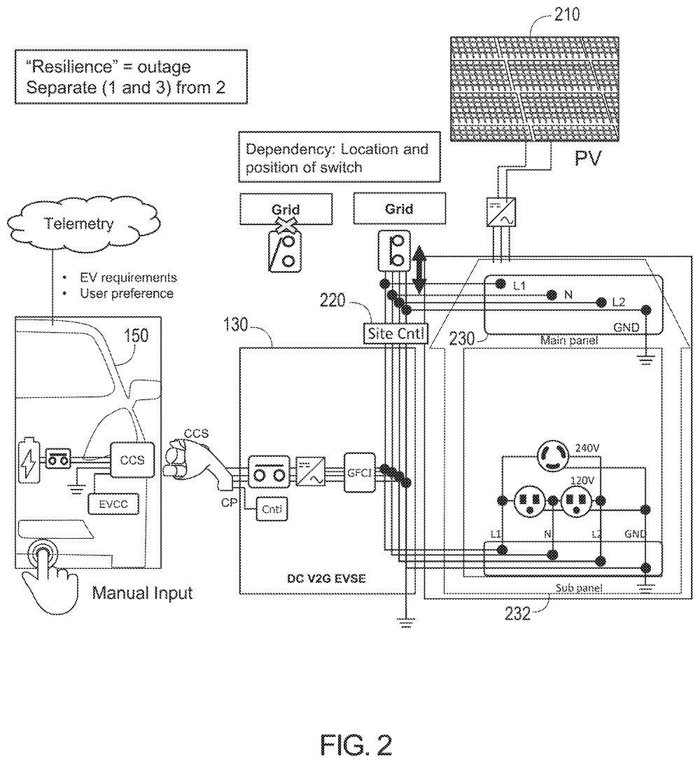

The OEM server 120 may pass dispatch commands along to a microgrid including an EMS managing one or more distributed energy resources (DER) 140 or directly to a DER. The microgrid may include an electric vehicle supply equipment (EVSE) 130, an electric vehicle (EV) 150 having an EV battery, a main panel (e.g., 230 of FIG. 2) connected to one or more energy consuming devices, a sub-panel (e.g., 232 of FIG. 2), one or more of the DER 140, associated inverters, etc. The EVSE 130 may include a computing device that may further include a processor 132, a memory 134, a storage drive 136, and a communication interface 138. The EVSE 130 may include separate computing devices that may process and execute electronic processes. According to one aspect, the EVSE 130 may include charging equipment and may be installed at a residential home or outside a residential home, for example, at a public or private charging station. The EVSE 130 may replenish the battery of the EV 150 using a charging energy source type generated and/or supplied by the utility provider.

The EV 150 may be associated with a user 160. The user 160 may have a mobile device 170, which may include a processor 172, a memory 174, a storage drive 176, and a communication interface 178. The storage drive 176 of the mobile device may have an application or ‘app’ or store application data related to the system for energy management, such as one or more user preferences, which will be described in greater detail herein.

The communication interfaces 128, 138 of the OEM server 120 and the EVSE 130 may also be configured to enable communication between the EV, the OEM server 120, the EVSE 130, the charging link, the utility computing infrastructure, the third-party computing infrastructure, and/or other components described herein to determine an aggregated demand, evaluate pricing schemes, power schemes, communicate the OEM charging policy option, and facilitate payment of one or more incentives.

Examples of energy consuming devices may include an appliance (e.g., refrigerator, oven, stove top, water heater, washer, dryer, dishwasher, air conditioner, etc.), a load consuming device, or electronic device (e.g., computers, laptops, cable box, television, portable device, etc.). The microgrid may be associated with a household, residential unit, office, business of the user, or be associated with premises identified by a utility provider. The utility computing infrastructure may include an electrical meter that may measure an amount of electrical energy consumed at the premises associated with the microgrid. In this manner, the microgrid may capture the energy usage of the plurality of energy consuming devices and the energy generation of one or more of the DER 140.

According to one aspect, the EVSE 130 may receive energy from the utility provider to replenish one or more electric storage mechanisms (e.g., the battery) of the EV 150 by charging the EV 150 through the charging link. According to one aspect, the EVSE 130 may be operably connected for computer communication with the EV 150 and/or the OEM server 120, for example, to transmit and receive the configuration information.

The charging link may be a wired or wireless link to the EVSE 130. Computer communication may occur also via the charging link and/or a wired or wireless communication link. According to one aspect, the EV 150, the EVSE 130, and/or the charging link may be operably controlled to initiate or terminate charging of the EV 150 from the EVSE 130 based on one or more charging schedules, and in accordance with the dispatch profile generated by the system for energy management. Accordingly, if the processor 132 modifies the dispatch profile based on an outage condition, the EV 150, the EVSE 130, and/or the charging link may be operably controlled to initiate or terminate charging according to the outage profile.

The OEM server 120 may receive the dispatch command from one of the upstream dispatch sources, consume the dispatch command, and pass or transmit the dispatch command along to the EVSE 130 or the charger connected to the EV 150 via the system for energy management. In this way, the dispatch command may flow through one of two paths, from either the utility 110 or the market operator 102 to the OEM server 120, to the EVSE 130, and to the EV 150.

According to one aspect, the EV 150 may include a vehicle computing device (e.g., a telematics unit, an electronic control unit (ECU)) with provisions for processing, communicating, and interacting with various components of the EV 150 and other components of the environment and/or microgrid. The vehicle computing device may include a processor, a memory, a storage drive, a position determination device (GPS), a plurality of vehicle systems (e.g., including the electric motor, the battery) and a communication interface. The components of the architecture, including the vehicle computing device, may be operably connected for computer communication via a bus (e.g., a Controller Area Network (CAN) or a Local Interconnect Network (LIN) protocol bus) and/or other wired and wireless technologies. The vehicle computing device as well as the EV 150 may include one or more vehicle systems, as described above.

Although the processor of the system for energy management is described herein as the processor 132 of the EVSE 130, it will be appreciated that any of the processors 122, 132, processor of the EV, 172, processor of site controller 220, etc. may perform any of the acts, actions, steps, or functions described herein.

FIG. 2 is an exemplary component diagram of a system for energy management, according to one aspect. As seen in FIG. 2, the microgrid may include other types of DER, such as a solar photo-voltaic (PV) system 210. Other types of DER are contemplated, including microturbines, small gas combustion turbines, internal combustion engines, fuel cells, battery cells, or photovoltaic cells. To supplement the energy received from one or more of the utility providers and offset the cost of buying energy, the microgrid may include DER which may generate energy for the energy consuming devices of the microgrid. Accordingly, the DER may provide additional energy to the microgrid in addition to the energy received from the utility provider via the utility infrastructure.

According to one aspect, the system for energy management may be implemented at the EVSE 130 or at a site controller 220 including a processor, a memory, and a communication interface 138. The communication interface 138 may include a receiver, a transmitter, a transceiver, etc. The communication interface 138 may receive configuration information associated with the microgrid and one or more distributed energy resources (DER) from the microgrid. For example, the communication interface 138 may receive a roster of dispatchable devices, including an inverter such as a PV inverter, a battery or other type of DER and an associated ability to energize individual inverters associated with each DER. Again, examples of different types of DER may include a stationary battery, a solar PV system 210, a fuel cell, a heat pump, or an energy generation device, among others. The site controller 220 may be connected to the EVSE 130, connected to an inverter for the PV system 210, attached directly to the EVSE 130, or be internal to the EVSE 130.

The system for energy management may have communications connectivity via the communication interface(s) 128, 138, 178 of each component of the microgrid at the premise so that the system may ordain and execute a plan. The site controller 220 may manage situational awareness inputs and mode control. The site controller 220 may control power vectors based on the presence of DER (e.g., an EV may not be at home), weather conditions, real-time on site generation, autonomous or aggregator control, etc.

For example, as seen in FIG. 2, the microgrid may include the PV system 210 and the EV 150. The communication interface 138 may poll or check to see whether the EV 150 is present and electrically connected to the microgrid and determine a status of the PV system 210. The status of a DER of one or more of the DER may include an EV connection status or a PV system interrupted status. In other words, the microgrid of FIG. 2 may have many different configurations depending on whether or not the EV 150 is plugged in, not plugged in, plugged in and fully charged or charged to a threshold level, plugged in and not charged to a threshold level, whether the PV system 210 is generating electricity due to sunny conditions (e.g., a non-interrupted status or excess status), whether the PV system 210 is not generating electricity due to cloudy conditions (e.g., an interrupted status), etc.

In any event, the communication interface 138 may receive configuration information associated with a microgrid and one or more DER, including a number of connected DER, a list of the DER, a status of one or more of the connected DER, a charge level associated with one or more of the DER, a capability associated with one or more of the DER, a program in which a DER is enrolled in, etc.

According to one aspect, a processor (e.g., any of 122, 132, processor of the EV, 172, processor of site controller 220, etc.) of the system for energy management may generate a dispatch profile to control one or more of the DER based on a detected outage, a type of DER connected to the microgrid, a set of default operating conditions, and/or a user preference. An outage may be detected through a meter, such as a voltage sensing component within a meter that the utility may use to identify a location and an extent of an outage. The utility may also utilize information from a substation or transformers on the line to determine or detect an outage.

According to one aspect, during normal operation, the EV 150, the EVSE 130, and the charging link may be configured to wirelessly communicate a respective state of charge (SOC) (e.g., battery charge remaining) of the EV 150 at one or more points in time. The EVSE 130 and the charging link may also wirelessly communicate charging information that may indicate the utilization of the EVSE 130 and the charging link at one or more of the points in time. Such data may be communicated through a network in the form of SOC data and charging data to the OEM server 120. The network may serve as a communication medium for the power system participants (e.g. microgrid, the utility providers, the OEM server 120, additional remote devices (e.g., databases, web servers, remote servers, application servers, intermediary servers, client machines, other portable devices, etc.).

According to one aspect, the storage drive(s) 126, 136 may store application data that may also include data pertaining to the policy application. The communication interface(s) 128, 138, 178 described herein may provide software, firmware and/or hardware to facilitate data input and output between the components of the vehicle computing device and other components, networks, and data sources. Further, the communication interface(s) 128, 138, 178 may facilitate communication between the EV and the OEM server to thereby send and receive data to and from the OEM server. Such data may include the SOC data sent from the EV to the OEM server and/or vehicle update data sent from a respective OEM to the EV. According to another aspect, the communication interface(s) 128, 138, 178 may also facilitate communication between the EV and a utility computing infrastructure and/or a third-party computing infrastructure to communicate data to and receive data from the respective infrastructures.

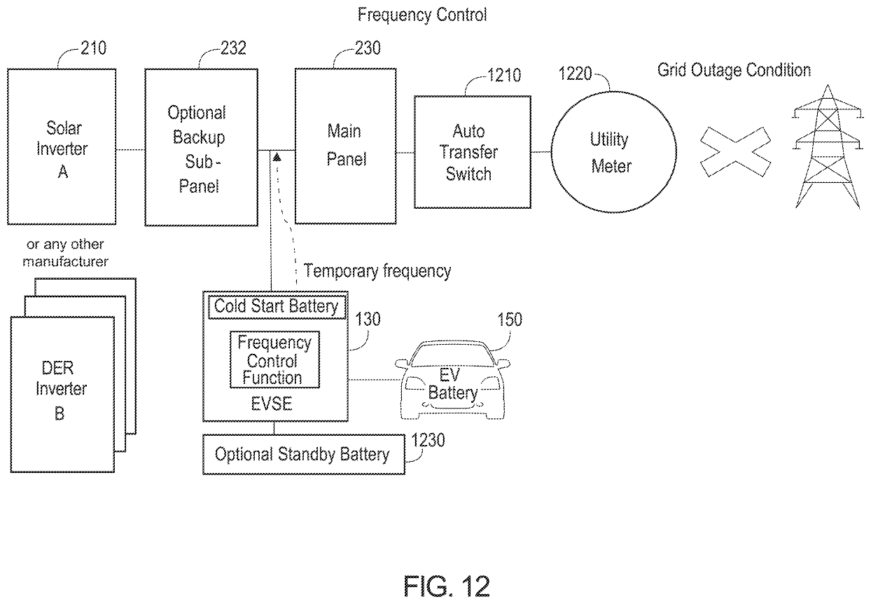

In any event, with reference to FIG. 2, the processor 132 may control a switch to disconnect the microgrid from a main power grid when a detected outage occurs. In this way, the processor 132 may generate the dispatch profile based on the detected outage as a first priority. In the event that the outage is detected, in order for the customer or user on premise to continue to operate independently in an islanded mode, an automatic transfer switch (ATS) (e.g., see FIGS. 2 and 1210 of FIG. 12) or a manual transfer switch may be activated. This transfer switch isolates the premise and microgrid from the grid so that no back feed may possibly occur. In this way, the transfer switch may isolate downstream components from the upstream components and initiate a transition from a normal operating condition to an outage or islanded operation condition by engaging in a public safety power shutoff (PSPS) mode.

In this regard, PSPS mode or grid isolation mode may be referred to as a scenario where smaller microgrids may be electrically cut-off from a larger infrastructure grid. Depending on how the grid has been cut-off, the microgrid may be established. Here, the system for energy management may be the controlling entity or controller that manages the operation of the behind the meter premise devices, such as one or more of the DER.

According to one aspect, the processor 132 may control the switch to disconnect the microgrid from the main power grid based on whether the EV 150 and/or the PV system 210 or other DER are present and connected to the microgrid. For example, if the EV 150 is not present, the switch may not be required to be set to disconnect the microgrid because no power is being pulled from the EV 150. If the EV 150 is present, the switch may be set to disconnect the microgrid because power is being pulled from the EV 150 to power the premise. As another example, if the PV system 210 is present and detected, the switch may be controlled to disconnect the microgrid from the main power grid to enable the PV system 210 to power the appliances on premises.

In an outage, no reference voltage and reference frequency are present. The system for energy management may facilitate a black start after the outage is detected by using the EVSE 130 and EV battery to provide a reference voltage and a reference frequency for governance of an inverter (e.g., inverter off-board of the EV). In this way, the EV 150 and the EVSE 130 may provide the reference frequency and reference voltage to enable the black start. One fundamental driver for whether or not black start may occur is the presence of the reference frequency and the reference voltage. The EVSE 130 and EV 150, as a pair, may provide this.

Thus, by utilizing the EV battery, the system for energy management may have the ability to alias the reference frequency and the reference voltage and thereby activate an inverter associated with the microgrid. Stated another way, the system for energy management may use the EV battery as the source of energy to produce an activated frequency and voltage that allows the inverter to come on in an orderly fashion. This enables the PV system 210, for example, to supply power as the PV system 210 normally would to the home or to the charger. Once islanded mode (e.g., the microgrid is isolated from the main grid) is established, the DER 140 and EVSE 130 may have different sets of operation conditions compared to the normal operating condition. In islanded mode, the EV 150 and EVSE 130 may be islanded and V2L or V2H operation may be enabled by the system for energy management after the reference voltage and reference frequency are detected and the switch is activated to isolate the microgrid from the main power grid. Thereafter, the system may energize and the PV system 210 may begin to produce power that can be exported to a load.

Next, the processor 132 may generate the dispatch profile based on the types of DER which are currently connected to the microgrid. The type of DER connected to the microgrid may include the solar PV system 210 or the EV 150 including the EV battery.

For example, if the EV 150 is connected to the microgrid and the EV battery has a sufficient threshold charge level, the EV battery may be utilized as a power source. If the EV is not connected to the microgrid, the EV battery cannot be utilized as a power source. Similarly, if there is a PV system 210 as part of the microgrid, energy from the PV system 210 may be utilized, depending on certain conditions (e.g., sufficient threshold charge level, non-interrupted status, or excess status), if available.

According to one aspect, the set of default operating conditions may be utilized to dictate or control a power vector. Default operation conditions may include charging the EV 150 via the EVSE 130 or having the PV system 210 supply power to the premise and associated appliances. Another default operation condition for the PV system 210 may be to supply excess power to the EVSE 130 to charge the EV 150.

Additionally, user preferences (e.g., from the storage drive 176 of the mobile device 170 or from the storage drive of the EV 150) may be setup to override at least some of the set of default operating conditions, thereby enabling the processor 132 of the system for energy management to create a dispatch profile controlling or prioritizing the direction of power flow during outage conditions.

For example, the user preferences may be setup to specify that a percentage of power from the PV system 210 is to be directed toward EV 150 charging and another percentage is to be directed to the premise and associated appliances unless the EV 150 is at a threshold charge level. As another example, the user preferences may be setup to specify that a percentage of power from the PV system 210 is to be directed toward EV 150 charging until the EV 150 is at a threshold charge level when a trip is planned within a future time window. The system for energy management may determine that the trip is planned within the time window based on information received by telematics, via a wireless network, from a mobile device of a user, based on historical travel data, etc.

As another example, if the PV system 210 is connected to the microgrid and holds a sufficient threshold charge level and the EV 150 is also connected to the microgrid but the EV battery is not at a sufficient, predetermined threshold charge level, the user preferences may dictate to the processor 132 to generate the dispatch profile to control the PV system 210 to charge the EV battery. As another example, if the PV system 210 is connected to the microgrid and holds a sufficient threshold charge level, the EV 150 is also connected to the microgrid but the EV battery is not at a sufficient, predetermined threshold charge level, and a refrigerator is connected to the microgrid via a main panel 230 or sub-panel 232, the user preferences may dictate to the processor 132 to generate the dispatch profile to control the PV system 210 to run the refrigerator rather than to charge the EV battery. In this way, the processor 132 may generate the dispatch profile to control one or more of the DER based on a first type of DER connected to the microgrid, a second type of DER connected to the microgrid, etc. Thus, the system for energy management may identify a state of the microgrid as a whole and identify actors within the microgrid (e.g., connected DER), and implement one or more actions according to a plan which is in accordance with the PSPS mode and in compliance and conformance to regulatory practices.

Further, the processor 132 of the system for energy management may generate the dispatch profile to control one or more of the DER based on a time of day, a day of year, a season, etc. According to one aspect, telemetry may optionally be utilized to receive information from the EV or the mobile device 170 associated with the EV 150 to receive the user preferences live, in real-time, or at a time prior to an outage.

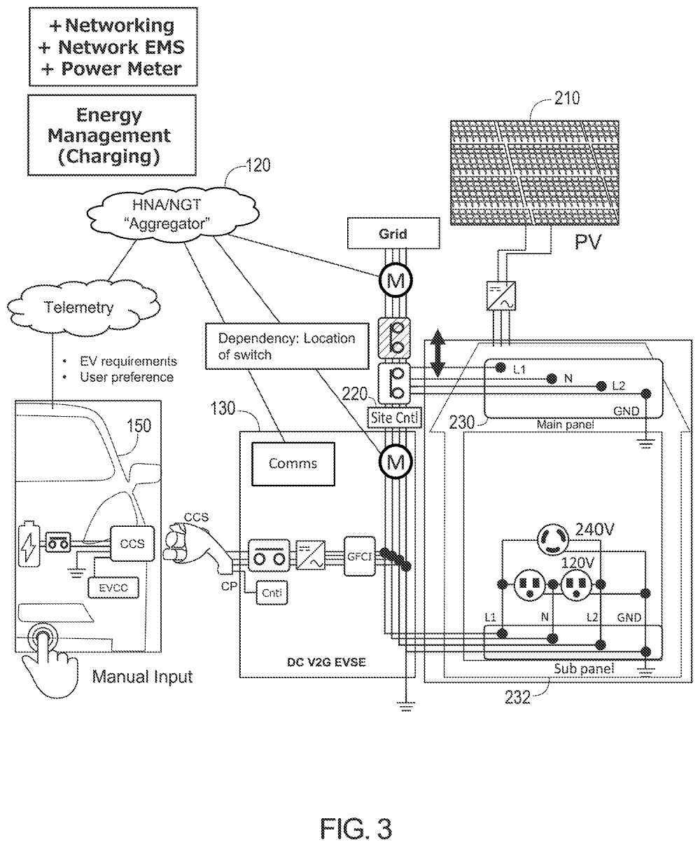

FIG. 3 is an exemplary component diagram of a system for energy management, according to one aspect. During normal operation, the processor 132 may generate the dispatch profile to control one or more of the DER based on time of use (TOU) rate information and a current time. For example, when the PV system 210 is detected and there is an associated energy storage system (ESS), the processor 132 may design the dispatch profile to store energy in the ESS for consumption during peak TOU rate hours.

As another example, the OEM server 120 may receive meter information from one or more of the meters on the premise. This meter information may include metrology information, how much power is available, historical consumption, external information, weather information, temperature information, real-time energy production (e.g., associated with the PV system 210, the EV battery, one or more other DER), etc. Based on this meter information, the OEM server 120 may generate an estimated power capability for the microgrid. For example, if cloud cover is forecasted for the premise location, the OEM server 120 may assume that the PV system 210 may not be able to contribute as much power as when sunny weather is present. As another example, if historical consumption indicates that the EV 150 is typically charged at a current time for an upcoming trip, then the OEM server 120 may determine that less overall estimated power is available for the microgrid. In any event, this external information may be consumed by the aggregator or OEM server 120.

The OEM server 120 may generate a corresponding dispatch command according to the user subscriptions and/or user preferences along with the current and anticipated status of the DER and microgrid. The processor 132 may generate the dispatch profile to utilize a higher amount of PV power based on the dispatch command from the OEM server 120 which may be generated based on the knowledge or configuration information from the microgrid, including the meter information from the premise. In this way, meter information including current active DER, a status of a DER, may be sent upstream to the OEM server 120, which may generate the dispatch command and transmit that dispatch command back to the system for energy management (e.g., which may be implemented on the EVSE 130 or connected to the PV inverter) for the processor 132 to generate the dispatch profile to control the microgrid DER accordingly.

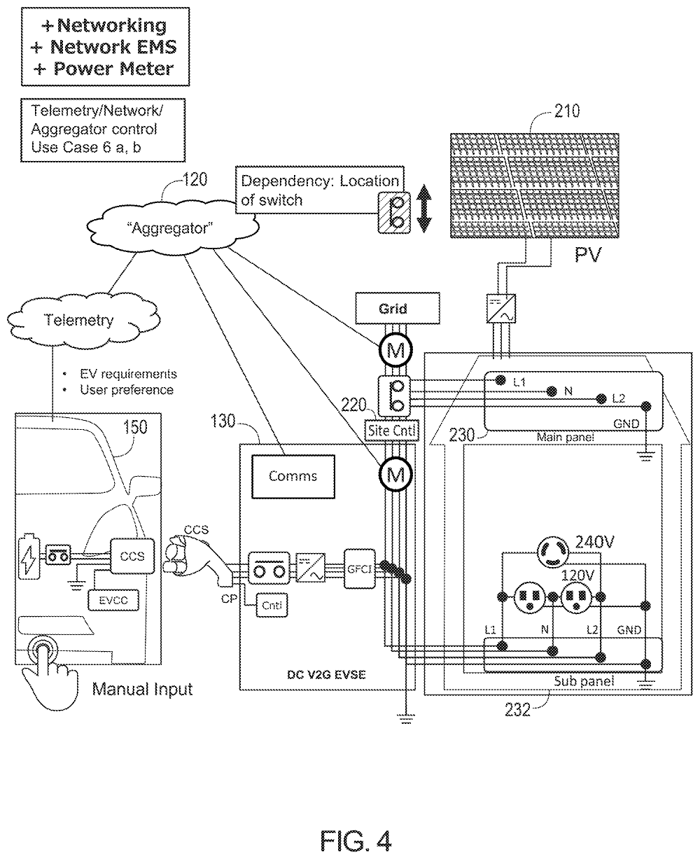

FIG. 4 is an exemplary component diagram of a system for energy management, according to one aspect. The OEM server 120 may obtain or receive the TOU rate information and configuration information from the microgrid and generate the dispatch command based on the TOU rate information and the configuration information from the microgrid. The OEM server 120 may transmit this dispatch command to the processor 132 of the system for energy management. The processor 132 may generate the dispatch profile to control one or more of the DER based on TOU rate information, a current time, a current day, etc. In FIG. 4, the processor 132 may prioritize the TOU rate information to generate the dispatch profile to be as cost efficient as possible. In other words, the processor 132 may prioritize energy storage for the TOU peak rate times so that a minimal amount of power is consumed from the grid during these times. The processor 132 may enable the user preferences to override this TOU rate information, however.

In this way, TOU rate information may be a default, but may be overridden by user preferences. User preferences may be set or obtained on an application on a mobile device linked to the EV, via a head unit on the EV, by an interface on the EVSE, etc.

According to one aspect, the user preferences may be transmitted directly to the OEM server along with any meter information or configuration information associated with the microgrid, and the OEM server may generate the dispatch command in a manner to take user preferences into account.

According to another aspect, the user preferences may not be transmitted directly to the OEM server along with any meter information or configuration information associated with the microgrid, and the OEM server may generate the dispatch command in a manner that does not take user preferences into account. According to this aspect, when the dispatch command is sent or transmitted to the system for energy management, the processor 132 may adjust the dispatch profile to account for the user preferences thereafter.

According to one aspect, the processor 132 may support reduction of customer energy bills by limiting the amount of energy used during on-peak pricing periods. Additionally, the processor 132 may build the dispatch profile to discharge energy from one or more of the DER, such as discharging energy from the EV battery during these on-peak pricing periods. These charge and discharge decisions may be based on pre-configured TOU rates and consumer preferences for the EV operation. According to one aspect, the processor 132 may cease EV battery charging during the on-peak pricing periods. According to another aspect, the processor 132 may have the PV system 210 charge the EV battery during the on-peak pricing periods. In any event, the processor 132 may generate the dispatch profile to turn on, turn off, adjust the charging or discharging for one or more of the DER based on the TOU rate information by minimizing usage from the grid during the on-peak pricing periods and maximizing usage during off-peak pricing periods.

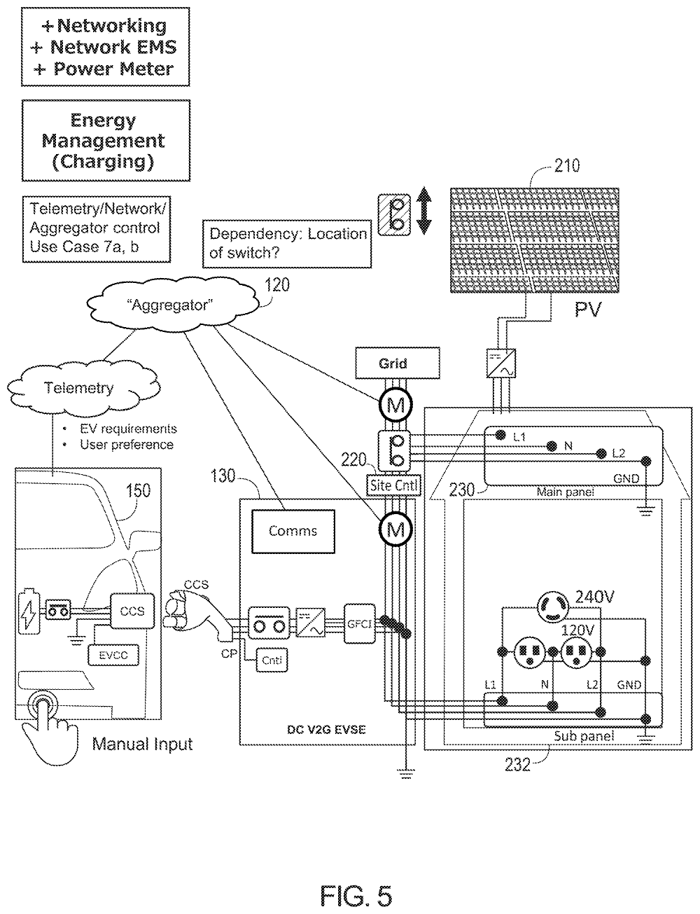

FIG. 5 is an exemplary component diagram of a system for energy management, according to one aspect. According to one aspect, the dispatch command may include a demand response (DR) request which may originate from a utility. The DR request may be a request for the microgrid to shut off charging to one or more of the DER or otherwise curtail power usage. The OEM server 120 may send the dispatch command including the DR request to a group of individuals or entities who are opted-into a DR program. Thus, when the time comes and it is desired that an overall load be curtailed, the OEM server 120 or aggregator may transmit the dispatch command including the DR request to the system for energy management. The system for energy management may perform a check in response to receiving the dispatch command including the DR request to determine that the EV is associated with the microgrid at the moment. In other words, the processor 132 may check to see that there is a load associated with the DR program (e.g., the EV 150 connected to the microgrid and charging) to be curtailed. The processor 132 of the system for energy management may then build the dispatch profile to curtail energy usage by stopping charging of the EV 150, at least until a predetermined time, for example.

The dispatch profile may allow the charging or use of some energy and may enable the user to select usage of DER according to a pre-set priority list or according to a predetermined travel plan (e.g., if the user is planning on utilizing the EV for travel, to charge the EV within the confines of the DR request (e.g., a turn-down in charging rather than a turn-off in charging) or to opt-out of participation for a particular DR event). The system for energy management may track and the OEM server 120 may receive an indication of whether or not a consumer and associated microgrid have participated in the DR event and the consumer may be compensated accordingly.

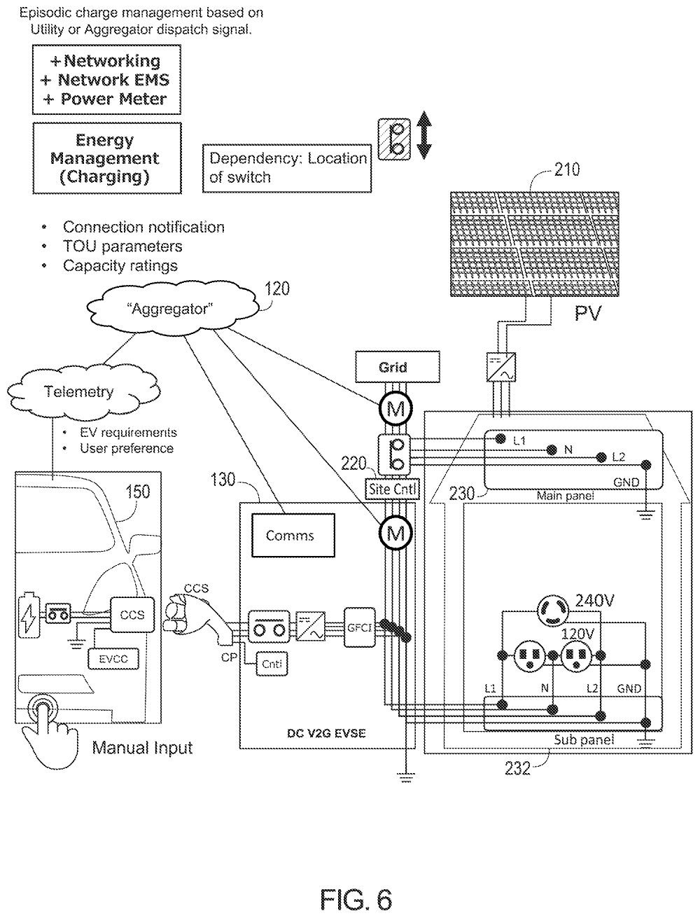

FIG. 6 is an exemplary component diagram of a system for energy management, according to one aspect. As discussed above, a system for energy management may include a processor, a memory, and a communication interface 138. The communication interface 138 may receive configuration information associated with a microgrid and one or more DER. The communication interface 138 may receive a dispatch command from an upstream server, such as the OEM server 120. The processor 132 may generate the dispatch profile to control one or more of the DER based on the dispatch command, a status of a DER of one or more of the DER connected to the microgrid, and/or a user preference.

The OEM server 120 may group configuration information for one or more microgrids, one or more DER, one or more subscribers, etc. The configuration information may include information from or about one or more of the energy consuming devices, one or more of the DER, and may include information such as a device type, a power magnitude (watts or kilowatts (kW)), average usage (hours per day), historical consumption data (kilowatt hours (kWh) per day), load patterns, state of charge (SOC) data, charge parameters, charging data and feedback, vehicle system data, historical usage data, operating and/or charging schedules, etc. By performing this grouping, the OEM server 120 may calculate an aggregated demand or an aggregated supply capability. The aggregated demand or aggregated supply capability may be a measure of how much electricity may be utilized or provided at a given point in time, and may be measured in kW or megawatts, for example.

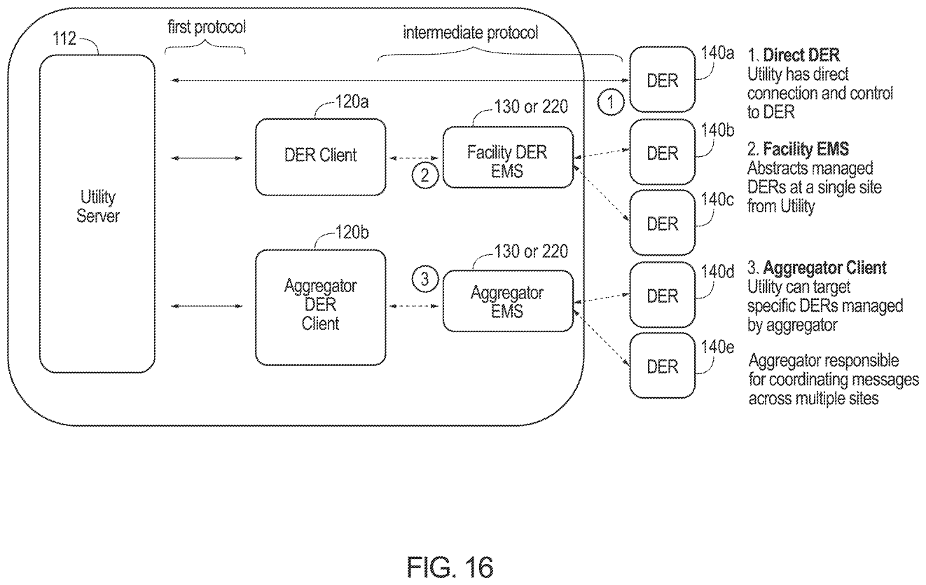

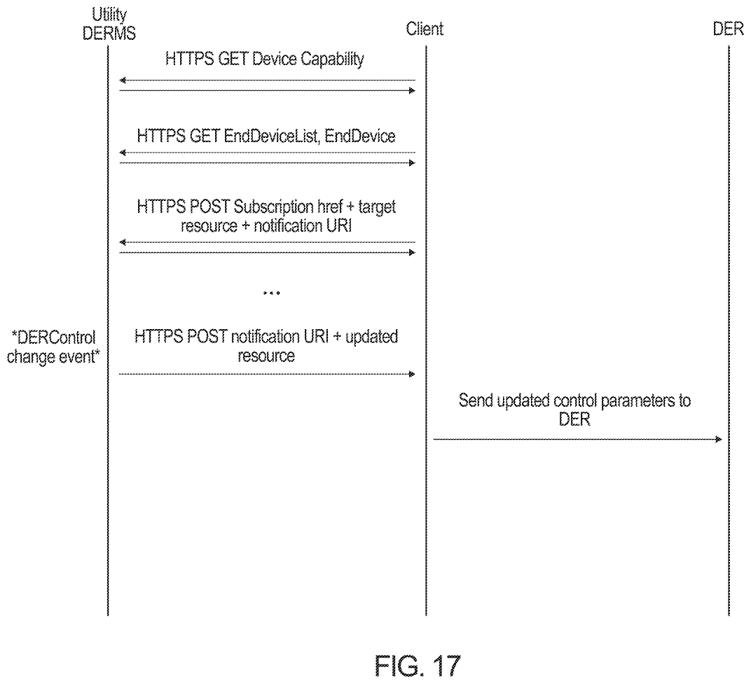

The OEM server may calculate the aggregated demand or supply capability based on the configuration information of the distinct devices of the energy consuming devices and the DER in the microgrid. According to another aspect, the aggregated demand or supply capability may be a subset of configuration information from the configuration information received from or about the distinct devices of the microgrid. Additional discussion regarding information which may be received by the OEM server is discussed herein with reference to FIGS. 16-17.

Typically, the utility may utilize voltage compensation devices to manage voltage on distribution lines. However, these voltage compensation devices may be costly to install and often require maintenance. However, it may be possible for the OEM server 120 or another upstream dispatch source to request assistance from a premise to provide real power or reactive power to compensate for instantaneous voltage drop or voltage droop. In this regard, the inverters that supply power to the PV system 210 or that supply power to the EV 150 may be configured to provide positive, negative, leading, lagging, real, or reactive power to achieve reactive grid optimization or volt VAR optimization. In this way, the system for energy management may be advantageous in that it may mitigate a need for the utility to install voltage compensation devices.

In this regard, a dispatch command may include a vehicle grid integration (VGI) request for real power or reactive power from the microgrid. According to one aspect, the OEM server may generate the VGI request in anticipation of bad or cloudy weather blocking an array of solar panels or other PV systems. The processor 132 may generate the dispatch profile to control one or more of the DER based on the VGI request by drawing the requested real power or reactive power (e.g., volt-ampere reactive or VAR) from one or more of the DER. In this way, the system for energy management enables the microgrid to act as a utility or a utility provider, when desired, as indicated via a received VGI request or VGI dispatch command.

The VGI request may facilitate DER control in the form of load shaping and voltage or frequency regulation, and may be done at a prescribed power factor. When significant or abnormal grid voltage conditions occur, (e.g., to PV generation being interrupted), the grid operator or utility may transmit a dispatch command including the VGI request to recruit DER from the microgrid for regulation services. In other words, these dispatch commands or dispatch requests may enable the DER to provide grid benefit by absorbing or supplying real and/or reactive power or curtailing use of either, as requested from the VGI request. In this way, the system for energy management may facilitate providing of a desired power factor (e.g., the relationship defining the ratio of real power over reactive power) for the utility.

According to one aspect, “user opt-out” triggers may affect one or more of the use cases described herein and the ability for the site controller 220 or system for energy management to manage the DER depending on conditions/opt-out duration/outage versus parallel modes and how the systems interface with external entities. Aggregators and/or utilities may be informed of opt-out preferences/duration profile and their respective misalignment with program requirements (e.g., limiting a number of opt-outs per predetermined period or interval).

Thus, the system for energy management enables the inverter to respond to a request from an upstream dispatch source so that the EV battery of the EV may be utilized as an energy source and to control a direction of the energy flow from the EV battery. In this way, algorithms supporting operation of a number of use cases of grid-connected bi-directional direct current (DC) EVSE 130 are provided herein. Each use case or figure may represent a unique situation, situational awareness, modes of operation and dispatch methods used to control the operation of an electric power processing device or DER for the purpose of managing power transfer to and from the EV 150, PV system 210, or DER to a plurality of uses and/or other DER at a location served by an electric power company. In these use cases, the charger may be located off-board from the EV 150 and control of the processes may be managed by user interfaces on the EV 150, remotely via the mobile device 170 communicatively coupled to the communication interface 138 of the system for energy management, or stationary device application programming interfaces (APIs), remotely via API to the charger or vehicle communicatively coupled to the communication interface 138 of the system for energy management, or via vehicle telemetry managed directly or indirectly by the automotive OEM.

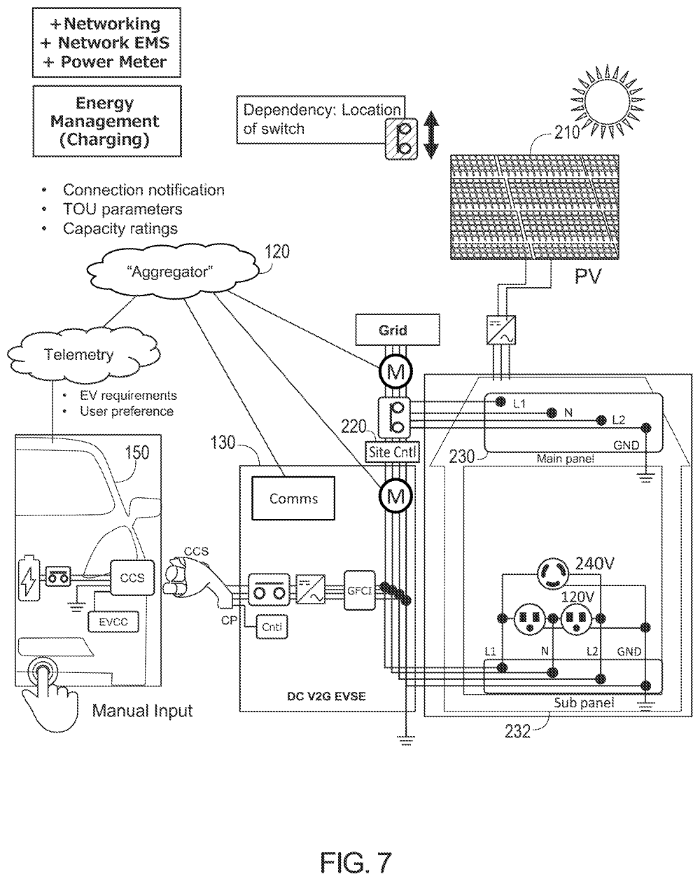

FIG. 7 is an exemplary component diagram of a system for energy management, according to one aspect. In FIG. 7, the PV system 210 may be implemented to facilitate peak shaving by providing energy to the premise. Additionally, the EV 150 may also be called upon to provide energy to reduce load utilized by appliances on the premise. Further, the PV system 210 may be utilized to charge the EV 150 as a way to mitigate the load.

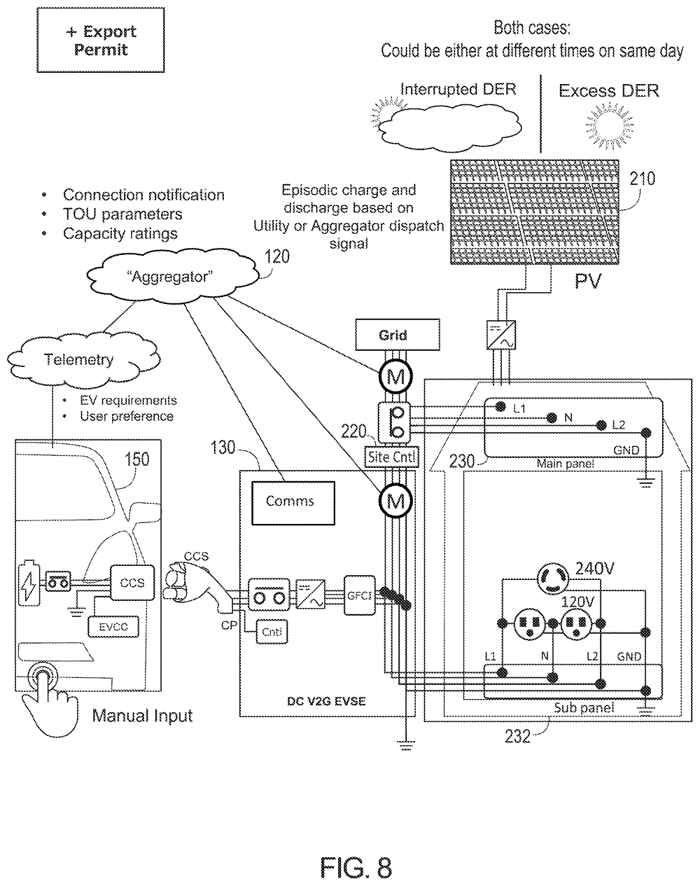

FIG. 8 is an exemplary component diagram of a system for energy management, according to one aspect. In FIG. 8, energy from the EV battery and/or the PV system 210 may be discharged to the grid if permitted by the dispatch command, and at a prescribed voltage. Here, the utility may send a voltage support request to the OEM server 120, and the OEM server 120 may identify one or more microgrids having excess energy capabilities or the ability to export power to the grid, and transmit the voltage support request to those associated systems for energy management. In response, the system for energy management may enable the EV 150 and the PV system 210 to put energy back onto the grid via the switch (e.g., ATS).

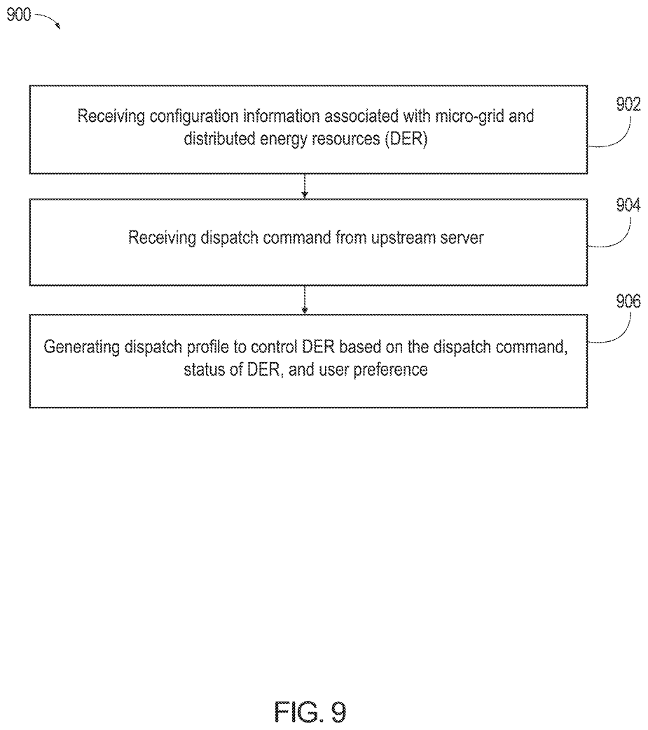

FIG. 9 is an exemplary flow diagram of a method 900 for energy management, according to one aspect. The method 900 for energy management may include receiving 902 configuration information associated with a microgrid and one or more distributed energy resources (DER), receiving 904 a dispatch command from an upstream server, generating 906 a dispatch profile to control one or more of the DER based on the dispatch command, a status of a DER of one or more of the DER connected to the microgrid, and a user preference.

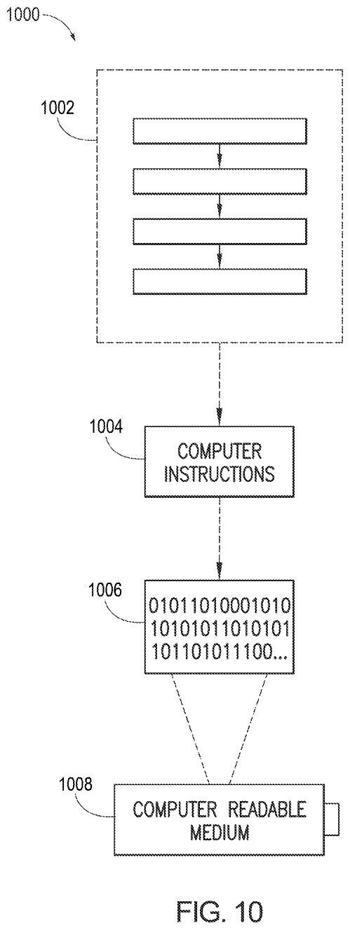

Still another aspect involves a computer-readable medium including processor-executable instructions configured to implement one aspect of the techniques presented herein. An aspect of a computer-readable medium or a computer-readable device devised in these ways is illustrated in FIG. 10, wherein an implementation 1000 includes a computer-readable medium 1008, such as a CD-R, DVD-R, flash drive, a platter of a hard disk drive, etc., on which is encoded computer-readable data 1006. This encoded computer-readable data 1006, such as binary data including a plurality of zero's and one's as shown in 1006, in turn includes a set of processor-executable computer instructions 1004 configured to operate according to one or more of the principles set forth herein. In this implementation 1000, the processor-executable computer instructions 1004 may be configured to perform a method 1002, such as the method 900 of FIG. 9. In another aspect, the processor-executable computer instructions 1004 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

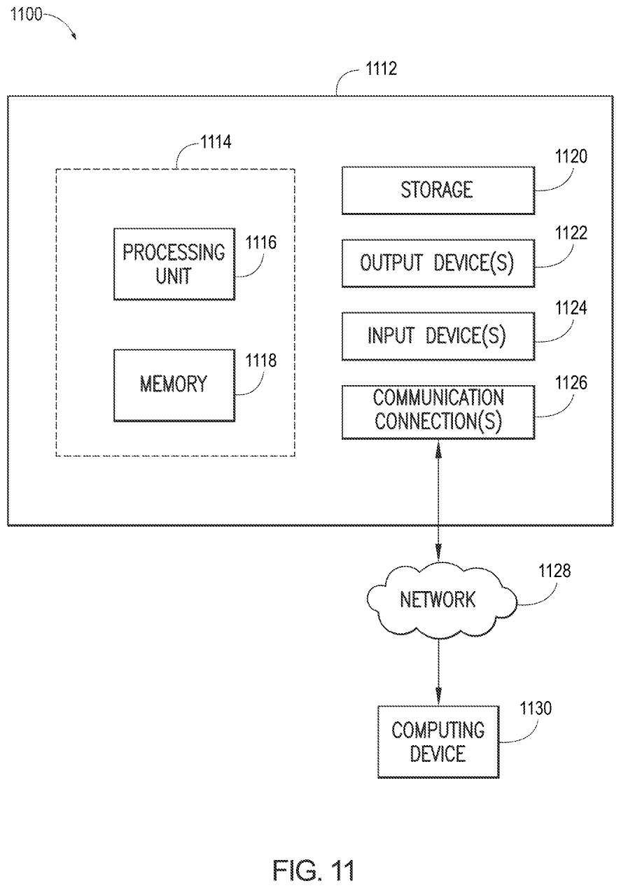

FIG. 11 and the following discussion provide a description of a suitable computing environment to implement aspects of one or more of the provisions set forth herein. The operating environment of FIG. 11 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 11 illustrates a system 1100 including a computing device 1112 configured to implement one aspect provided herein. In one configuration, the computing device 1112 includes at least one processing unit 1116 and memory 1118. Depending on the exact configuration and type of computing device, memory 1118 may be volatile, such as RAM, non-volatile, such as ROM, flash memory, etc., or a combination of the two. This configuration is illustrated in FIG. 11 by dashed line 1114.

In other aspects, the computing device 1112 includes additional features or functionality. For example, the computing device 1112 may include additional storage such as removable storage or non-removable storage, including, but not limited to, magnetic storage, optical storage, etc. Such additional storage is illustrated in FIG. 11 by storage 1120. In one aspect, computer readable instructions to implement one aspect provided herein are in storage 1120. Storage 1120 may store other computer readable instructions to implement an operating system, an application program, etc. Computer readable instructions may be loaded in memory 1118 for execution by the at least one processing unit 1116, for example.

The term “computer readable media” as used herein includes computer storage media. Computer storage media includes volatile and nonvolatile, removable, and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 1112. Any such computer storage media is part of the computing device 1112.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 1112 includes input device(s) 1124 such as keyboard, mouse, pen, voice input device, touch input device, infrared cameras, video input devices, or any other input device. Output device(s) 1122 such as one or more displays, speakers, printers, or any other output device may be included with the computing device 1112. Input device(s) 1124 and output device(s) 1122 may be connected to the computing device 1112 via a wired connection, wireless connection, or any combination thereof. In one aspect, an input device or an output device from another computing device may be used as input device(s) 1124 or output device(s) 1122 for the computing device 1112. The computing device 1112 may include communication connection(s) 1126 to facilitate communications with one or more other devices 1130, such as through network 1128, for example.

FIG. 12 is an exemplary component diagram of a system for energy management, according to one aspect. As seen in FIG. 12, a solar inverter (e.g., part of the PV system 210) is connected to the optional sub-panel 232, which may be connected to the main panel 230. The main panel 230 may be connected to the EVSE 130, which may be connected to the EV 150 including the EV battery and an optional battery 1230. The main panel 230 may be connected to an automatic transfer switch (ATS) 1210, which may be connected to a utility meter 1220.

According to one aspect, frequency control may be implemented via the system for energy management or the EVSE 130 in this configuration. During a grid outage, which may be recognized or detected by the utility meter 1220, in order to control the on or off operation of the PV system 210 inverter or other DER inverter (e.g., DER inverter B), the EVSE 130 may output a temporary “out-of-bounds” frequency or signal, causing the PV system 210 to de-energize under a “trip” condition of the applicable interconnection standard for DER. Once islanded, (Auto Transfer Switch 1210 is opened), the EVSE 130 may subsequently output an “in-bounds” signal associated with an allowable voltage and frequency, allowing the PV system 210 to automatically re-energize, having detected the permissive nominal voltage and frequency condition. Any co-located DER within the ATS governed domain may be controlled in this fashion and this may be universally applicable to all interconnection-compliant inverter-based DER.

The cold start battery within the EVSE 130 may not be sufficient to carry a load. This battery may enable communications and contactor operation for start-up during outages. The optional battery 1230 may be used to support a permissive voltage and frequency during episodes when the EV 150 may temporarily disconnect and may be applied to support sustained operation of the co-located DER. The frequency control may be enabled for a time period defined by the supportive capacity of the optional battery 1230.

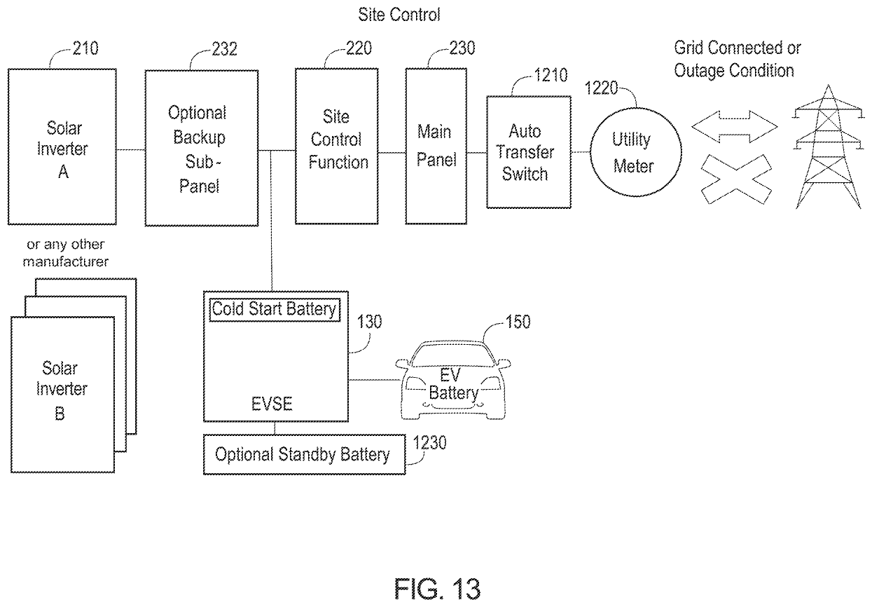

FIG. 13 is an exemplary component diagram of a system for energy management, according to one aspect. As seen in FIG. 13, a solar inverter (e.g., part of the PV system 210) is connected to the optional sub-panel 232, which may be connected to the site controller 220. The site controller 220 may be connected to the main panel 230. The main panel 230 may be connected to the EVSE 130, which may be connected to the EV 150 including the EV battery and an optional battery 1230. The main panel 230 may be connected to an automatic transfer switch (ATS) 1210, which may be connected to a utility meter 1220.

During connected grid or outage conditions, the site controller 220 may manage operational characteristics of the EVSE 130 and any additional DER at a site, subject to the applicable interconnection standard for DER. Once islanded, (Auto Transfer Switch 1210 is opened), the EVSE 130 may output an “in-bounds” allowable voltage and frequency and the DER at the site may automatically re-energize, having detected the relevant permissive conditions. Utilization of the site controller 220 may apply to any co-located DER within the ATS governed domain and requires compliant communications to each DER. According to this aspect, the frequency control may be deactivated from the site controller 220.

Similarly to FIG. 12, the cold start battery within the EVSE 130 may not be sufficient to carry a load. This battery may enable communications and contactor operation for start-up during outages. The optional battery 1230 may be used to carry the load during episodes when the EV 150 may temporarily disconnect and may be applied to support sustained operation of the co-located DER. The site controller 220 may be enabled for a time period defined by the supportive capacity of the optional battery 1230.

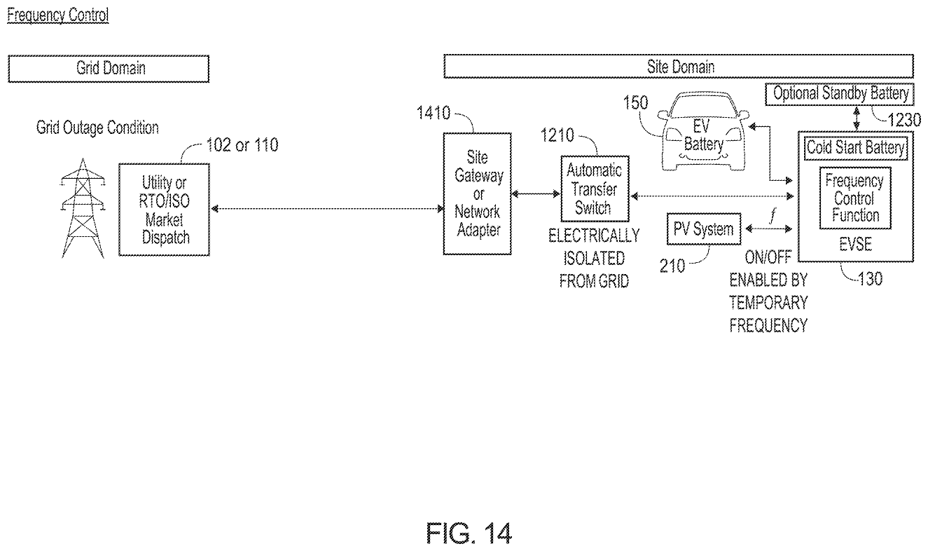

FIG. 14 is an exemplary component diagram of a system for energy management, according to one aspect. As seen in FIG. 14, the utility 110 or the market operator 102 may transmit a dispatch command to the gateway 1410 which may be associated with the site controller 220 or the EVSE 130. Downstream from this gateway, the ATS 1210 may be opened to create an islanded condition for the microgrid. From here, the EVSE 130 may utilize the frequency control signal to control islanded operation and manage the PV system 210, the EV 150 and associated EV battery, and the optional battery 1230, among other components of the microgrid.

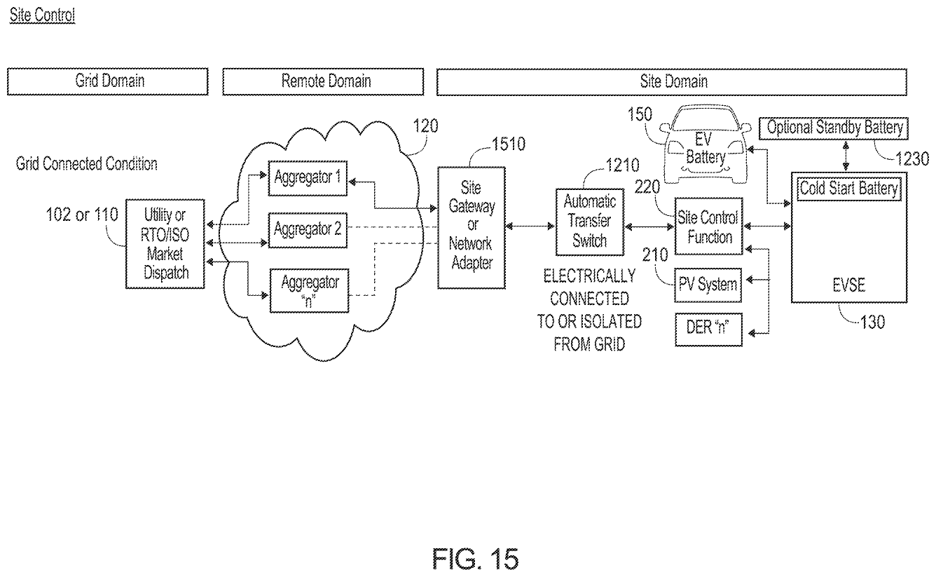

FIG. 15 is an exemplary component diagram of a system for energy management, according to one aspect. As seen in FIG. 15, the utility 110 or the market operator 102 may transmit a dispatch command to the OEM server 120 or aggregators, followed by the gateway 1510, which may be associated with the site controller 220 or the EVSE 130. Downstream from this gateway, the ATS 1210 may be opened to create an islanded condition for the microgrid. From here, the site controller 220 and EVSE 130 may utilize the frequency control signal to control islanded operation and manage the PV system 210, the EV 150 and associated EV battery, and the optional battery 1230, additional DER 140, among other components of the microgrid. As previously discussed, the frequency control may be deactivated from the site controller 220 in FIG. 15.

FIG. 16 is an exemplary component diagram of a system for energy management, according to one aspect. As seen, the utility server 112 may utilize a first protocol to communicate with one or more servers, such as DER client server 120a or aggregator DER client servers 120b. The DER client server 120a may communicate with a facility DER EMS (e.g., 130 or 220) which may manage one or more DER 140a-140e. The aggregator DER client server 120b may communicate with an aggregator EMS (e.g., 130 or 220) which may manage one or more DER 140a-140e.

FIG. 17 is an exemplary flow diagram of a method for energy management, according to one aspect. FIG. 17 illustrates different types of computer communication, function calls, etc. between a utility server, a client, and DER. For example, GETDeviceCapability may provide links to function sets for devices. GETEndDeviceList may return a roster of applicable end devices which may be used based on a subscribed basis to dispatch a cluster or group of DER. GETEndDevice may return an addressable and dispatchable DER end node with a uniquely identifiable communication port to be used for relay of control messages. FunctionSetAssignmentsList may return an agreed upon roster of FunctionSets, such as those contemplated by the Common Smart Inverter Protocol (CSIP) and may be used to define groups. DERControlList may return a roster of applicable control structures supporting DER dispatch which may be used to control an aggregate of DER. DERProgramList may return a roster of applicable utility or market operations programs which support services which DER may be dispatched to fulfill. DERProgram may be a command associated with a defined structure for dispatchability of DER to perform a specifically designated function or service. DERInfo may return information about DER, such as a status, availability (e.g., time, power, reactive power availability), capabilities, settings, etc.

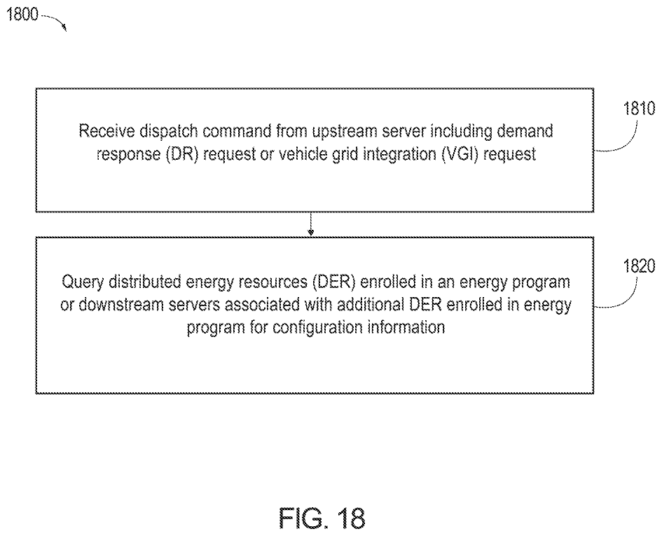

FIG. 18 is an exemplary flow diagram of a method 1800 for energy management, according to one aspect. The method 1800 for energy management may include receiving 1810 a dispatch command from an upstream server, the dispatch command including a demand response (DR) request or a vehicle grid integration (VGI) request and querying 1820 one or more distributed energy resources (DER) enrolled in an energy program or one or more downstream servers associated with one or more additional DER enrolled in the energy program for configuration information associated with the DR request or the VGI request.

According to one aspect, a method for energy management may include receiving a dispatch command from an upstream server, the dispatch command including a demand response (DR) request or a vehicle grid integration (VGI) request, querying one or more distributed energy resources (DER) enrolled in an energy program or one or more downstream servers associated with one or more additional DER enrolled in the energy program for configuration information associated with the DR request or the VGI request to generate a query result, and transmitting the query result to the upstream server to indicate whether the DR request or the VGI request is possible.

The method for energy management may include receiving configuration information associated with a microgrid associated with one or more of the additional DER to generate the query result, receiving a roster of applicable end devices associated with the corresponding query to generate the query result, receiving an addressable and dispatchable DER end node with a uniquely identifiable communication port to be used for relay of control messages to generate the query result, receiving an agreed upon roster of FunctionSets to generate the query result, receiving a roster of applicable control structures supporting DER dispatch for controlling a group of DER to generate the query result, receiving a roster of applicable utility or market operations programs which support services which DER may be dispatched to fulfill to generate the query result, receiving a defined structure for dispatchability of DER to perform a specifically designated function or service to generate the query result, or receiving information pertaining to a corresponding DER including a status, an availability, a capability, and a setting of the corresponding DER to generate the query result.

According to one aspect, a system for energy management may include a processor, a memory, and a communication interface 128, 138. The communication interface 128, 138 may receive a dispatch command from an upstream server, the dispatch command including a demand response (DR) request or a vehicle grid integration (VGI) request. The communication interface 128, 138 may query one or more distributed energy resources (DER) enrolled in an energy program or one or more downstream servers associated with one or more additional DER enrolled in the energy program for configuration information associated with the DR request or the VGI request to generate a query result. The communication interface 128, 138 may transmit the query result to the upstream server to indicate whether the DR request or the VGI request is possible.

The communication interface 128, 138 may receive configuration information associated with a microgrid associated with one or more of the additional DER. The corresponding query may include a GETEndDeviceList command which returns a roster of applicable end devices associated with the corresponding query. The corresponding query may include a GETEndDevice command which returns an addressable and dispatchable DER end node with a uniquely identifiable communication port to be used for relay of control messages. The corresponding query may include a FunctionSetAssignmentsList command which returns an agreed upon roster of FunctionSets. The corresponding query may include a DERControlList command which returns a roster of applicable control structures supporting DER dispatch for controlling a group of DER. The corresponding query may include a DERProgramList command which returns a roster of applicable utility or market operations programs which support services which DER may be dispatched to fulfill. The corresponding query may include a DERProgram command which may be a command associated with a defined structure for dispatchability of DER to perform a specifically designated function or service. The corresponding query may include a DERInfo command which returns information pertaining to a corresponding DER including a status, an availability, a capability, and a setting of the corresponding DER. One or more of the additional DER may be a stationary battery, a solar photo-voltaic (PV) system, a fuel cell, a heat pump, or an energy generation device.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for energy management, comprising:
a processor;
a memory; and
a communication interface,
wherein the communication interface receives a dispatch command from an upstream server, the dispatch command including a demand response (DR) request or a vehicle grid integration (VGI) request,
wherein the communication interface queries one or more distributed energy resources (DER) enrolled in an energy program or one or more downstream servers associated with one or more additional DER enrolled in the energy program for configuration information associated with the DR request or the VGI request to generate a query result.

2. The system for energy management of claim 1, wherein the communication interface receives configuration information associated with a microgrid associated with one or more of the additional DER.

3. The system for energy management of claim 1, wherein the corresponding query includes a GETEndDeviceList command which returns a roster of applicable end devices associated with the corresponding query.

4. The system for energy management of claim 1, wherein the corresponding query includes a GETEndDevice command which returns an addressable and dispatchable DER end node with a uniquely identifiable communication port to be used for relay of control messages.

5. The system for energy management of claim 1, wherein the corresponding query includes a FunctionSetAssignmentsList command which returns an agreed upon roster of FunctionSets.

6. The system for energy management of claim 1, wherein the corresponding query includes a DERControlList command which returns a roster of applicable control structures supporting DER dispatch for controlling a group of DER.

7. The system for energy management of claim 1, wherein the corresponding query includes a DERProgramList command which returns a roster of applicable utility or market operations programs which support services which DER are dispatched to fulfill.

8. The system for energy management of claim 1, wherein the corresponding query includes a DERProgram command which is a command associated with a defined structure for dispatchability of DER to perform a specifically designated function or service.

9. The system for energy management of claim 1, wherein the corresponding query includes a DERInfo command which returns information pertaining to a corresponding DER including a status, an availability, a capability, and a setting of the corresponding DER.

10. The system for energy management of claim 1, wherein one or more of the additional DER is a stationary battery, a solar photo-voltaic (PV) system, a fuel cell, a heat pump, or an energy generation device.

11. A method for energy management, comprising:
receiving a dispatch command from an upstream server, the dispatch command including a demand response (DR) request or a vehicle grid integration (VGI) request;
querying one or more distributed energy resources (DER) enrolled in an energy program or one or more downstream servers associated with one or more additional DER enrolled in the energy program for configuration information associated with the DR request or the VGI request to generate a query result; and
transmitting the query result to the upstream server to indicate whether the DR request or the VGI request is possible.

12. The method for energy management of claim 11, comprising receiving configuration information associated with a microgrid associated with one or more of the additional DER to generate the query result.

13. The method for energy management of claim 11, comprising receiving a roster of applicable end devices associated with the corresponding query to generate the query result.

14. The method for energy management of claim 11, comprising receiving an addressable and dispatchable DER end node with a uniquely identifiable communication port to be used for relay of control messages to generate the query result.

15. The method for energy management of claim 11, comprising receiving an agreed upon roster of FunctionSets to generate the query result.

16. The method for energy management of claim 11, comprising receiving a roster of applicable control structures supporting DER dispatch for controlling a group of DER to generate the query result.

17. The method for energy management of claim 11, comprising receiving a roster of applicable utility or market operations programs which support services which DER are dispatched to fulfill to generate the query result.

18. The method for energy management of claim 11, comprising receiving a defined structure for dispatchability of DER to perform a specifically designated function or service to generate the query result.

19. The method for energy management of claim 11, comprising receiving information pertaining to a corresponding DER including a status, an availability, a capability, and a setting of the corresponding DER to generate the query result.

20. A system for energy management, comprising:
a processor;
a memory; and
a communication interface,
wherein the communication interface receives a dispatch command from an upstream server, the dispatch command including a demand response (DR) request or a vehicle grid integration (VGI) request,
wherein the communication interface queries one or more distributed energy resources (DER) enrolled in an energy program or one or more downstream servers associated with one or more additional DER enrolled in the energy program for configuration information associated with the DR request or the VGI request to generate a query result, and
wherein the communication interface transmits the query result to the upstream server to indicate whether the DR request or the VGI request is possible.
